(19) United States
(12) Patent Application Publication
(10) Pub. No.: US 2025/0301108 A1
(43) Pub. Date: Sep. 25, 2025

(54) PROJECTION METHOD, AND PROJECTOR

(71) Applicant: SEIKO EPSON CORPORATION, Tokyo (JP)

(72) Inventor: Kohei YANAI, MATSUMOTO-SHI (JP)

(21) Appl. No.: 19/082,682

(22) Filed: Mar. 18, 2025

(30) Foreign Application Priority Data
Mar. 25, 2024 (JP) 2024-047705

(51) Int. Cl. H04N 9/31

(52) U.S. Cl. CPC H04N 9/3194; H04N 9/3188

(57) ABSTRACT

A projection method includes: acquiring a plurality of pieces of captured image data by capturing an image of each of M structured lights projected from a projector onto a projection target with a camera, M being a natural number equal to or greater than 2; determining, based on the plurality of pieces of captured image data, whether at least one first structured light whose image is not normally captured, of the t M structured lights, is present; and projecting N structured lights including the at least one first structured light onto the projection target, N being a natural number smaller than M, when it is determined that the at least one first structured light is present.

The present application is based on, and claims priority from JP Application Serial Number 2024-047705, filed Mar. 25, 2024, the disclosure of which is hereby incorporated by reference herein in its entirety.

### BACKGROUND

### 1. Technical Field

The present disclosure relates to a projection method AND a projector.

### 2. Related Art

JP-A-2022-174999 discloses a technique of specifying a correspondence relationship between a plurality of pixels of an image projected from a projection device and a plurality of pixels of a captured image captured by an image capturing device using a gray code image as an example of a structured light.

In the technique described in JP-A-2022-174999, optimization of the number of projected structured lights when, while a plurality of structured lights are projected onto a display surface, image capturing of the structured light by the image capturing device is not normally performed due to disturbance such as ambient light is not considered.

### SUMMARY

A projection method according to an aspect of the present disclosure includes: acquiring a plurality of pieces of captured image data by capturing an image of each of M structured lights projected from a projector onto a projection target with a camera, M being a natural number equal to or greater than 2; determining, based on the plurality of pieces of captured image data, whether at least one first structured light whose image is not normally captured, of the M structured lights, is present; and projecting N structured lights including the at least one first structured light onto the projection target, N being a natural number smaller than M, when it is determined that the at least one first structured light is present.

A projection method according to another aspect of the present disclosure includes: acquiring a plurality of pieces of captured image data by capturing an image of each of M structured lights projected from a projector onto a projection target with a camera, M being a natural number equal to or greater than 2; determining, based on the plurality of pieces of captured image data, whether at least one first structured light whose image is not normally captured, of the M structured lights, is present; determining, based on change information indicating a change in one or both of a position and a posture of the projector with respect to the projection target, whether one or both of the position and the posture are changed; projecting N structured lights including the at least one first structured light onto the projection target, N being a natural number smaller than M, when it is determined that the at least one first structured light is present and one or both of the position and the posture are not changed; and projecting the M structured lights onto the projection target when it is determined that the at least one first structured light is present and one or both of the position and the posture are changed.

A system according to an aspect of the present disclosure includes: an optical device; and a processing device configured to control an operation of the optical device, in which the processing device is configured to acquire a plurality of pieces of captured image data in which an image of each of M structured lights projected from the optical device onto a projection target is captured by a camera, M being a natural number equal to or greater than 2, determine, based on the plurality of pieces of captured image data, whether at least one first structured light whose image is not normally captured, of the M structured lights, is present, and project N structured lights including the at least one first structured light onto the projection target, N being a natural number smaller than M, when it is determined that the at least one first structured light is present.

A non-transitory computer-readable storage medium storing a program according to an aspect of the present disclosure causes a computer to execute operations including: acquiring a plurality of pieces of captured image data in which an image of each of M structured lights projected from a projector onto a projection target is captured by a camera, M being a natural number equal to or greater than 2; determining, based on the plurality of pieces of captured image data, whether at least one first structured light whose image is not normally captured, of the M structured lights, is present; and causing the projector to project N structured lights including the at least one first structured light onto the projection target, N being a natural number smaller than M, when it is determined that the at least one first structured light is present.

### BRIEF DESCRIPTION OF THE DRAWINGS

FIG. 1 is a diagram showing an overview of a system used for a projection method according to a first embodiment.

FIG. 2 is a block diagram of a projector used in the projection method according to the first embodiment.

FIG. 3 is a flowchart showing a flow of the projection method according to the first embodiment.

FIG. 4 is a diagram showing a user interface image.

FIG. 5 is a diagram showing a first pattern.

FIG. 6 is a diagram showing abnormality detection when a gray code pattern is used as a structured light.

FIG. 7 is a diagram showing abnormality detection when a phase shift pattern is used as the structured light.

FIG. 8 is a diagram showing abnormality detection when a phase shift pattern is used as the structured light.

FIG. 9 is a diagram showing an example of a message.

FIG. 10 is a block diagram of a projector used in a projection method according to a second embodiment.

FIG. 11 is a flowchart showing a flow of the projection method according to the second embodiment.

FIG. 12 is a block diagram of a projector used in a projection method according to a third embodiment.

FIG. 13 is a flowchart showing a flow of the projection method according to the third embodiment.

### DESCRIPTION OF EMBODIMENTS

As below, preferred embodiments according to the present disclosure will be described with reference to the accompanying drawings. In the drawings, dimensions and scales of the respective parts are different from real ones as appropriate, and some parts are schematically shown in order to facilitate understanding. Further, the scope of the present disclosure is not limited to these embodiments unless particularly described to limit the present disclosure in the following description.

### 1. First Embodiment

### 1-1. Overview of System

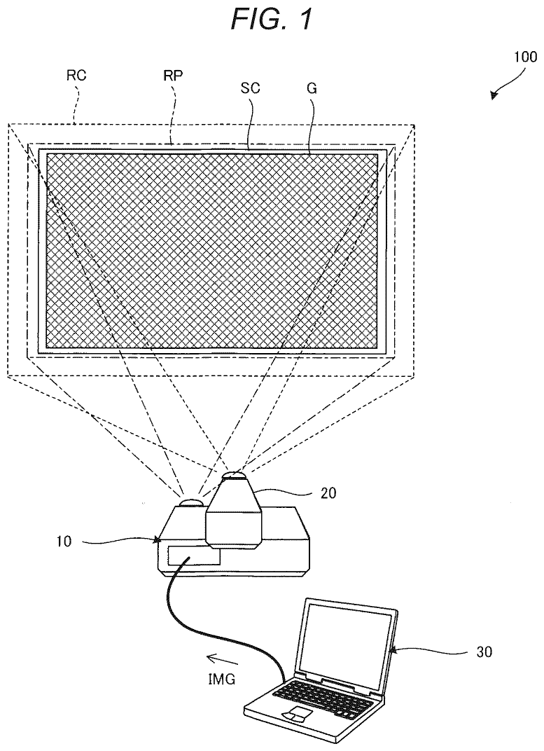

FIG. 1 is a diagram showing an overview of a system 100 used for a projection method according to a first embodiment. The system 100 is a projection system that projects a projection image G onto a projection target SC.

The projection target SC is formed of, for example, a surface of an object such as a screen. In the example shown in FIG. 1, an outer shape of the projection target SC is a rectangular shape. The outer shape of the projection target SC is not limited to the example shown in FIG. 1, but may be optional. The projection target SC is not limited to a flat surface, but may be, for example, a surface curved in a concave shape or a convex shape.

As shown in FIG. 1, the system 100 includes a projector 10, a camera 20, and a terminal device 30.

The projector 10 is a display device that projects the projection image G represented by image data IMG output from the terminal device 30 onto the projection target SC. In the example shown in FIG. 1, the projection image G is projected onto a rectangular region substantially over the entire projection target SC. The projector 10 can project the projection image G in a region RP including the projection target SC. In FIG. 1, the projection image G is shaded. A projection position and a shape of the projection image G with respect to the projection target SC are not limited to the example shown in FIG. 1, but may be optional.

The projector 10 in the embodiment has function of controlling an operation of the camera 20 and a function of adjusting the shape of the projection image G, using an image capturing result with the camera 20.

The camera 20 is a digital camera having an image capturing device such as a charge coupled device (CCD) or a complementary metal oxide semiconductor (CMOS).

The camera 20 captures an image of a region RC. The region RC is a region including the projection image G projected onto the projection target SC. In the example shown in FIG. 1, the region RC includes the region RP. The camera 20 may be an element of the projector 10.

The terminal device 30 is a computer having a function of supplying the image data IMG to the projector 10. In the example shown in FIG. 1, the terminal device 30 is a notebook computer. Note that the terminal device 30 is not limited to a notebook computer, but may be, for example, a desktop computer, a smartphone, or a tablet terminal, or may be a video player, a digital versatile disk (DVD) player, a Blu-ray disc player, a hard disk recorder, a television tuner, a set-top box for cable television (CATV), or a video game machine.

### 1-2. Projector

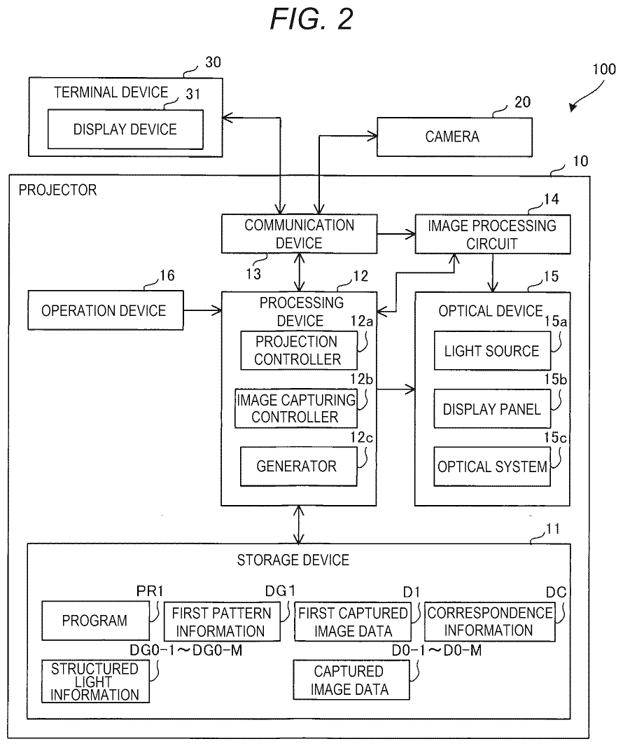

FIG. 2 is a block diagram of the projector 10 used in the projection method according to the first embodiment. FIG. 2 shows a coupling state of the camera 20 and the terminal device 30 to the projector 10 in addition to the projector 10. In the example shown in FIG. 2, the terminal device 30 includes a display device 31. The display device 31 is a display device including various display panels such as a liquid crystal display panel and an organic EL display panel.

As shown in FIG. 2, the projector 10 includes a storage device 11, a processing device 12, a communication device 13, an image processing circuit 14, an optical device 15, and an operation device 16. These devices are communicably coupled to one another.

The storage device 11 is a storage device that stores a program to be executed by the processing device 12 and data to be processed by the processing device 12. The storage device 11 includes, for example, a hard disk drive or a semiconductor memory. A part or all the storage device 11 may be provided in a storage device, a server, or the like outside the projector 10.

A program PR1, first pattern information DG1, structured light information DG0, first captured image data D1, and correspondence information DC are stored in the storage device 11.

The program PR1 is a program for execution of the projection method, which will be described later in detail.

The first pattern information DG1 is information indicating a first pattern G1 to be described later. The first pattern G1 is an image of a uniform first color and is projected onto the projection target SC by the projector 10. The first color is not particularly limited, but is, for example, white or black. The first pattern information DG1 may be in the structured light information DG0.

The first captured image data D1 is information indicating a captured image acquired by capturing an image of the first pattern G1 projected onto the projection target SC with the camera 20.

Structured light information DG0-1 to DG0-M is information indicating M structured lights G0 that are pattern images used in a structured light method. Here, M is a natural number equal to or greater than 2. A pattern of the structured light G0 is not particularly limited, and examples thereof include a phase shift pattern, a binary code pattern, a dot pattern, a rectangular pattern, a polygonal pattern, a checker pattern, a gray code pattern, and a random dot pattern. Hereinafter, the structured light information DG0-1 to DG0-M may be referred to as “structured light information DG0” without distinction. The number of pieces of structured light information DG0, that is, a specific value of M is not particularly limited, but is 46 when the pattern of the structured light G0 is a gray code pattern, for example. As the value of M increases, an effect of the present disclosure becomes more remarkable.

Captured image data D0-1 to D0-M is information indicating a captured image acquired by the camera 20 to capture an image of each of the M structured lights G0 sequentially projected onto the projection target SC. Hereinafter, each of the captured image data D0-1 to D0-M may be referred to as “captured image data D0” without distinction.

The correspondence information DC is information indicating a correspondence relationship between coordinates in a display coordinate system of the projector 10 and coordinates in an image capturing coordinate system of the camera 20. The display coordinate system of the projector 10 is a coordinate system in which a pixel of a display panel 15b to be described later is set as a coordinate value. The image capturing coordinate system of the camera 20 is a coordinate system in which a pixel of an image capturing device of the camera 20 is set as a coordinate value.

The processing device 12 is a processing device having a function of controlling each part of the projector 10 and a function of processing various kinds of data. For example, the processing device 12 includes a processor such as a central processing unit (CPU). The processing device 12 may be implemented by a single processor or may be implemented by a plurality of processors. Part or all of functions of the processing device 12 may be implemented by hardware such as a digital signal processor (DSP), an application specific integrated circuit (ASIC), a programmable logic device (PLD), and a field programmable gate array (FPGA). The processing device 12 may be integrated with at least a part of the image processing circuit 14.

The communication device 13 is a communication device that can communicate with various devices, and acquires the image data IMG from the terminal device 30, and communicates with the camera 20. For example, the communication device 13 is a wired communication device such as a wired local area network (LAN), a universal serial bus (USB), and a high definition multimedia interface (HDMI), or a wireless communication device such as a low power wide area (LPWA), wireless LAN including Wi-Fi, and Bluetooth. Each of “HDMI”, “Wi-Fi”, and “Bluetooth” is a registered trademark.

The image processing circuit 14 is a circuit that performs necessary processing on the image data IMG from the communication device 13 and inputs the data to the optical device 15. The image processing circuit 14 has, for example, a frame memory, not illustrated, loads the image data IMG in the frame memory, executes various kinds of processing such as resolution conversion processing, resizing processing, and distortion correction processing, as appropriate, and inputs the data to the optical device 15. Here, the above-described correspondence information DC is appropriately used in the various kinds of processing. The image processing circuit 14 may execute processing such as on screen display (OSD) processing of generating image information for showing a menu, operation guidance, or the like, and combining the information with the image data IMG, according to need.

The optical device 15 is a device that projects an image light onto the projection target SC. The optical device 15 includes at least a light source 15a, the display panel 15b, and an optical system 15c.

The light source 15a includes, for example, light sources such as halogen lamps, xenon lamps, ultra-high-pressure mercury lamps, light emitting diodes (LEDs), or laser light sources, which emit red, green, and blue lights. The display panel 15b is a light modulator including three light modulation elements provided corresponding to red, green, and blue. The light modulation elements include, for example, transmissive liquid crystal panels, reflective liquid crystal panels, or digital mirror devices (DMDs), and modulate corresponding color lights to generate image lights of each color. The image light of each color generated by the display panel 15b are combined together by a light combining system into a full-color image light. The optical system 15c is a projection system including a projection lens or the like that forms an image of the full-color image light from the display panel 15b and projects the image on the projection target SC. The optical device 15 may include an LED module including one or more LEDs instead of the display panel 15b. In this case, the optical device 15 may be omitted. In this case, an image based on the image data IMG is drawn on the LED module.

The operation device 16 is a device that receives an operation from a user. For example, the operation device 16 includes an operation panel and a remote control light receiver, not illustrated. The operation panel is provided in an exterior casing of the projector 10 and outputs a signal based on an operation by the user. The remote control light receiver receives an infrared signal from a remote controller, not illustrated, decodes the infrared signal, and outputs a signal based on an operation of the remote controller. The operation device 16 is provided according to need and may be omitted.

In the above-described projector 10, the processing device 12 executes the program PR1 stored in the storage device 11 and thus functions as a projection controller 12a, an image capturing controller 12b, and a generator 12c. Therefore, the processing device 12 includes the projection controller 12a, the image capturing controller 12b, and the generator 12c.

The projection controller 12a controls operations of the image processing circuit 14 and the optical device 15. More specifically, the projection controller 12a controls an operation of the optical device 15 with respect to the projection target SC to cause the optical device 15 to project the projection image G. More specifically, the projection controller 12a causes the optical device 15 to project the first pattern G1 to be described later based on the first pattern information DG1 onto the projection target SC or to project a second image G2 to be described later based on the structured light information DG0 onto the projection target SC.

The image capturing controller 12b controls an operation of the camera 20. More specifically, the image capturing controller 12b acquires the first captured image data D1 by causing the camera 20 to capture an image of the first pattern projected onto the projection target SC or acquires the captured image data DO by causing the camera 20 to capture an image of the structured light projected onto the projection target SC. Then, the image capturing controller 12b stores the acquired first captured image data D1 and captured image data DO in the storage device 11.

The generator 12c generates the correspondence information DC based on the captured image data DO, and appropriately adds processing necessary for generating the correspondence information DC based on the first captured image data D1.

### 1-3. Projection Method

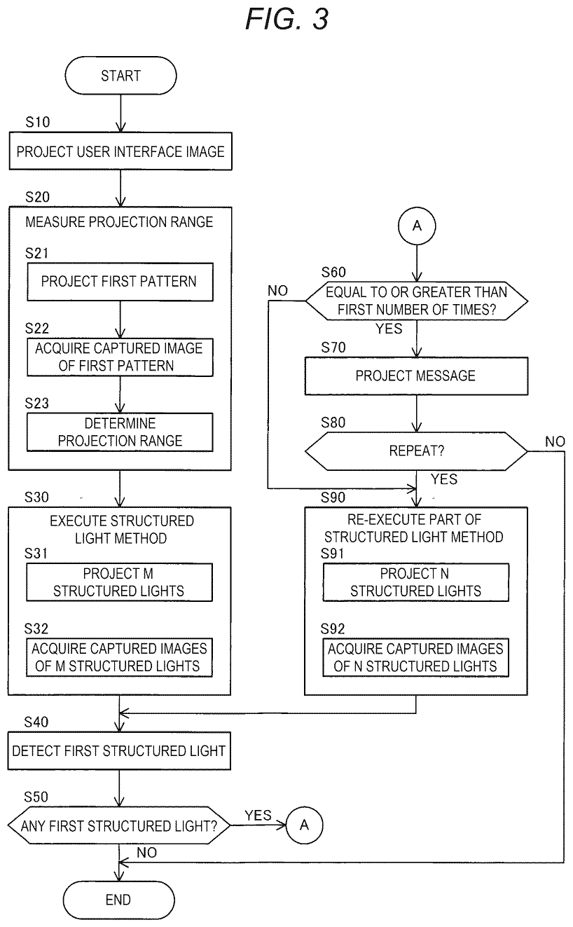

FIG. 3 is a flowchart showing a flow of the projection method according to the first embodiment. The projection method is executed by the processing device 12 as an example of “computer” executing the program PR1 using the above-described system 100.

As shown in FIG. 3, the projection method according to the embodiment includes steps S10 to S90. Here, as described above, the projector 10 includes the optical device 15 and the processing device 12 that controls an operation of the optical device 15, and the processing device 12 executes steps S10 to S90. The program PR1 causes the processing device 12 to execute steps S10 to S90.

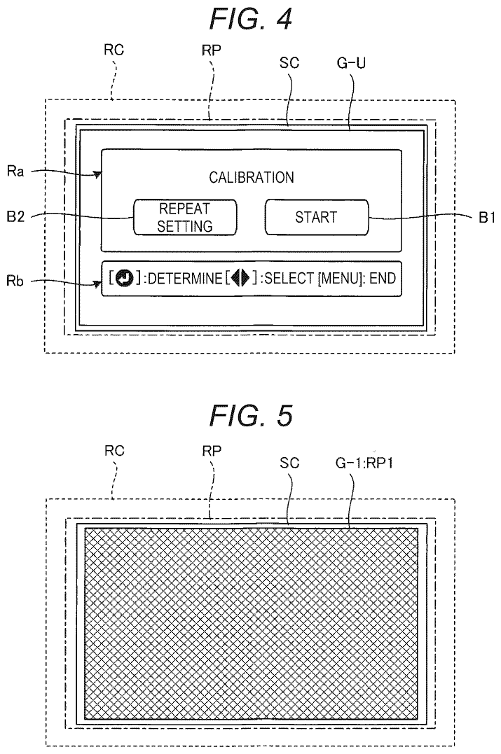

The processing device 12 first executes step S10. In step S10, a user interface image G-U is projected from the projector 10. The user interface image G-U includes an item for setting a first number of times, which is a determination criterion in step S60. A specific example of the user interface image G-U will be described later with reference to FIG. 4.

After step S10, the processing device 12 executes step S20. In step S20, a projection range is measured in which each of the M structured lights GS is projected onto the projection target SC. Specifically, step S20 includes step S21, step S22, and step S23 in this order.

Before step that S30, is, before the M structured lights GS are sequentially projected from the projector 10 onto the projection target SC, the processing device 12 projects the first pattern G1 to be described later from the projector 10 onto the projection target SC in step S21. The projection is performed by the projection controller 12a controlling operations of the image processing circuit 14 and the optical device 15 based on the first pattern information DG1. The first pattern G1 is a uniform first color image. Details of the first pattern G1 will be described later with reference to FIG. 5.

In step S22, the processing device 12 executes capturing of an image of the first pattern G1 with the camera 20, which will be described later, projected from the projector 10 onto the projection target SC. The image capturing is performed by the image capturing controller 12b controlling an operation of the camera 20. By this image capturing, the first captured image data D1 indicating an image capturing result is generated, and the first captured image data D1 is stored in the storage device 11.

In step S23, the processing device 12 determines, based on the first pattern G1 indicated by the first captured image data D1, a projection range RP1 to be described later in which each of the M structured lights GS is projected onto the projection target SC.

After step S20, the processing device 12 executes step S30. In the step S30, an image of each of M (M is a natural number equal to or greater than 2) structured lights GS projected from the projector 10 onto the projection target SC is captured by the camera 20 to acquire a plurality of pieces of captured image data DO. Specifically, step S30 includes step S31 and step S32.

In step S31, the processing device 12 sequentially projects the M structured lights GS to be described later from the projector 10 onto the projection target SC. This projection is performed by the projection controller 12a controlling the operations of the image processing circuit 14 and the optical device 15 based on the structured light information DG0-1 to DG0-M.

In step S32, the processing device 12 acquires M pieces of captured image data DO, that is, captured image data D0-1 to D0-M by capturing an image of each of M structured lights GS with the camera 20, which will be described later, projected from the projector 10 onto the projection target SC. The acquisition is performed by the image capturing controller 12b controlling the operation of the camera 20. By this acquisition, M pieces of captured image data DO are generated, and the generated M pieces of captured image data DO are stored in the storage device 11.

In step S30 described above, after executing step S31 and step S32, the processing device 12 associates coordinates in the display coordinate system of the projector 10 with coordinates in the image capturing coordinate system of the camera 20 based on the captured image data D0-1 to D0-M. This association is performed by the generator 12c based on the captured image data D0-1 to D0-M. For example, the processing device 12 performs association by searching for a feature point of the structured light GS in the captured image data D0-1, acquiring a coordinate value of the feature point in the image capturing coordinate system, and specifying a coordinate value of a pixel of the display panel 15b corresponding to the coordinate value of the feature point in the image capturing coordinate system. The processing device 12 executes similar calculation on the captured image data D0-2 to D0-M. The correspondence information DC is generated by the correlation, and the generated correspondence information DC is stored in the storage device 11. That is, in the embodiment, step S31 and step S32 are alternately repeated in step S30. Therefore, in step S30, the projection of the structured light GS and the imaging capturing of the structured light GS are performed M times each. This association may be executed before an end of the processing shown in FIG. 3, and may not be executed in step S30. For example, this association may be performed when it is determined that there is no first structured light GS1 in step S50 to be described later, or may be performed in step S90 to be described later.

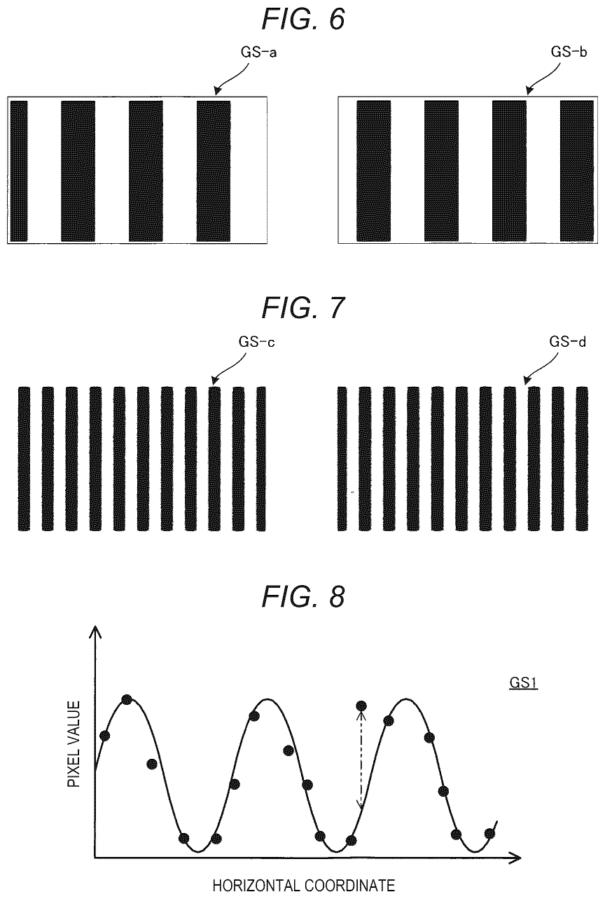

After step S30, the processing device 12 executes step S40. In step S40, based on the captured image data D0-1 to D0-M, processing is executed to detect the first structured light GS1 that is a structured light GS whose image is not normally captured, of the M structured lights GS. Details of this detection will be described below with reference to FIGS. 6 to 8.

After step S40, the processing device 12 executes step S50. In step S50, it is determined whether at least one first structured light GS1 whose image is not normally captured, of the M structured lights GS, is present based on the plurality of pieces of captured image data DO by using a processing result of step S40.

In the embodiment, whether at least one first structured light GS1 is present in step S50 is determined based on the M structured lights GS in the projection range RP1 to be described later. Therefore, when there is the structured light GS whose image is not normally captured outside the projection range RP1 to be described later, of the M structured lights GS, the processing device 12 determines that the structured light GS does not correspond to the first structured light GS1.

When it is determined that at least one first structured light GS1 is present (step S50: YES), the processing device 12 executes step S60. In step S60, it is determined whether N structured lights GS in step S90 are repeatedly projected equal to or greater than a first number of times. That is, in step S60, it is determined whether the number of repetitions of the projection of the N structured lights GS in step S90 is equal to or greater than the first number of times. The first number of times is not particularly limited and is any desired number of times. In the embodiment, the first number of times can be changed using the user interface image G-U to be described later. Step S60 may be omitted.

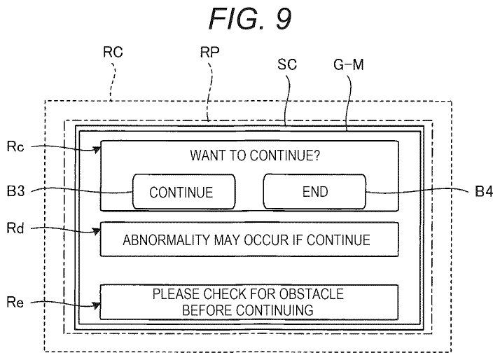

When the number of repetitions of the projection of the N structured lights GS in step S90 is equal to or greater than the first number of times (step S60: YES), the processing device 12 executes step S70. In step S70, the projector 10 projects messages Rd and Re to be described later. Specific examples of the messages Rd and Re will be described later with reference to FIG. 9. Step S70 may be omitted.

After step S70, the processing device 12 executes step S80. In step S80, it is determined whether to execute step S90 based on an input result for an image G-M to be described later. Step S80 may be omitted.

When the number of repetitions of the projection of the N structured lights GS in step S90 is less than the first number of times (step S60: NO), or when it is determined to repeat step S90 (step S80: YES), the processing device 12 executes step S90. In step S90, the processing device 12 causes the optical device 15 to project N (N is a natural number larger than 0 and smaller than M) structured lights GS, including at least one first structured light GS1, onto the projection target SC. Specifically, step S90 includes step S91 and step S92.

In step S91, the projector 10 sequentially projects, onto the projection target SC, the N structured lights GS including the first structured light GS1, which is one of the M structured lights GS whose image cannot be normally captured. This projection is performed by the projection controller 12a controlling the operations of the image processing circuit 14 and the optical device 15 based on the structured light information DG0-1 to DG0-M.

In the step S92, an image of each of the N structured lights GS projected from the projector 10 onto the projection target SC is captured by the camera 20 to acquire the N pieces of captured image data DO. The acquisition is performed by the image capturing controller 12b controlling the operation of the camera 20. By this acquisition, the N pieces of captured image data DO are generated, and the generated N pieces of captured image data DO are stored in the storage device 11. At this time, among the M pieces of captured image data DO already stored in the storage device 11, the captured image data DO corresponding to the N pieces of captured image data DO generated in step S92 is updated by overwriting or the like.

After step S90, the processing device 12 returns to step S40. Accordingly, step S40 and step S50 are executed again.

When it is determined that the first structured light GS1, which is the structured light GS whose image is not normally captured, is not present (step S50: NO), or when it is determined in step S90 that there is no repeating (step S80: NO), the processing device 12 ends the processing. When the processing device 12 determines that the first structured light GS1 is not present after executing step S90 (step S50: NO), the processing device 12 performs the association using a captured image of a second structured light GS2 that is a structured light GS whose image is normally captured in step S30, of the M structured lights GS, and a captured image of a third structured light GS3 that is a structured light GS whose image is normally captured in step S90. That is, when the association is performed when it is determined that the first structured light GS1 is not present after step S90 is executed (step S50: NO), the processing device 12 reuses the captured image of the second structured light GS2 whose image is normally captured in step S30, of the M structured lights GS, after step S50.

FIG. 4 is a diagram showing the user interface image G-U. In step S10, for example, as shown in FIG. 4, the user interface image G-U is projected from the projector 10 onto the projection target SC.

The user interface image G-U is a projection image G for receiving an operation from the user. In the example shown in FIG. 4, the user interface images G-U include regions Ra and Rb.

The region Ra has a button B1 and a button B2. The button B1 is a display for starting the processing after step S20. The button B2 is a display for setting a value of the first number of times in step S60. The button B2 for changing the first number of times is not limited to being in the user interface image G-U, and may be in, for example, the image G-M to be described later.

The region Rb is a display showing an operation method of the operation device 16 for the user interface image G-U.

In the user interface image G-U described above, when the button B1 is operated, the execution of step S20 is started after display of the user interface image G-U is ended. When the button B2 is operated, a widget for changing the value of the first number of times is displayed. When the value of the first number of times is set, after the display of the user interface image G-U ends, the execution of step S20 is started.

FIG. 5 is a diagram showing the first pattern G-1. In step S21, as shown in FIG. 5, the first pattern G-1 indicated by the first pattern information DG1 is projected from the projector 10 onto the projection target SC. In FIG. 5, an outer edge of the first pattern G-1 is located inside an outer edge of the region RP, but the outer edge of the first pattern G-1 may coincide with the outer edge of the region RP.

In step S22, the processing device 12 causes the camera 20 to capture an image of the first pattern G-1 in the region RC including the first pattern G-1 projected onto the projection target SC.

In step S23, the processing device 12 determines the projection range RP1 by performing edge detection of the first pattern G-1 in an image indicated by an image capturing result of the first pattern G-1. Therefore, the processing device 12 determines a range in which the first pattern G-1 is projected as the projection range RP1. In the embodiment, the first pattern G-1 is a pattern using all pixels of the display panel 15b. The first pattern G-1 may be a pattern using some pixels of the display panel 15b. For example, the processing device 12 may appropriately change a size of the first pattern G-1 based on size information such as an aspect ratio of the image data IMG.

FIG. 6 is a diagram showing abnormality detection when a gray code pattern is used as the structured light GS. In FIG. 6, when the gray code pattern is used as the structured light GS, of the M structured lights GS, structured lights GS-a and GS-b, which are two structured lights GS that form inverted images of each other, are representatively shown. The structured light GS-b has a pattern in which bright portions and dark portions of the structured light GS-a are inverted.

In a gray code method, as shown in FIG. 6, robustness may be increased using a difference between a captured image of the structured light GS-a that is a normal pattern and a captured image of the structured light GS-b that is an inverted pattern. For example, when the difference is larger than zero, it is determined to be white, and when the difference is smaller than zero, it is determined to be black. In the gray code method, a set of such a plurality of normal patterns and inverted patterns is used.

Such a difference between the captured image of the normal pattern and the captured image of the inverted pattern changes due to temporary presence of a person or a shadow thereof between the projector 10 and the projection target SC or a change in an amount of light such as illumination of a space in which the projector 10 is installed or light from a window.

Therefore, when the gray code pattern is used as the structured light GS, in step S40, for each set of the normal pattern and the inverted pattern, an absolute value of a difference between a pixel value of a pixel constituting the captured image of the normal pattern and a pixel value of a pixel constituting the captured image of the inverted pattern is calculated for each pixel, and the number of pixels n1, which is the number of pixels having an absolute value equal to or greater than a threshold value t1, and the number of pixels n2, which is the number of pixels having an absolute value less than the threshold value t1, are counted. The pixel value is a value that characterizes a color or brightness of a pixel, such as a gradation value or a luminance value. Since the number of pixels n1 has a large absolute value, the number of pixels n1 has relatively high reliability. Since the number of pixels n2 has a small absolute value, the number of pixels n2 has relatively low reliability. Since colors of the normal pattern and the inverted pattern are inverted from each other, all the pixels are to satisfy a condition of being equal to or greater than the threshold value t1. However, when images of the normal pattern and the inverted pattern are captured, for example, a shadow of a person may overlap the bright portion of the structured light GS-a, and brightness of the bright portion may decrease to brightness close to the dark portion. In such a case, even when a set of the normal pattern and the inverted pattern is used, a pixel that is less than the threshold value t1 occurs, and a pixel that is to be originally determined to be white is determined to be black.

In step S50, the processing device 12 determines whether a ratio r=n2/n1 of the number of pixels n2 to the number of pixels n1 is equal to or greater than the threshold value t2 before and after the set of the normal pattern and the inverted pattern. Specifically, when a set of a normal pattern and an inverted pattern projected in a first period is defined as a first set, a set of a normal pattern and an inverted pattern projected in a second period after the first period is defined as a second set, and a ratio q of a ratio r2 in the second set to a ratio r1 in the first set is equal to or greater than the threshold value t2, it is determined that there is a structured light GS whose image is not normally captured, of the M structured lights GS. For example, in the first period, r1=0.5 if the number of pixels n1=100 and the number of pixels n2=50, and in the second period, r2=0.875 if the number of pixels n1=80 and the number of pixels n2=70. At this time, for example, when the threshold value t2=0.51/0.5=1.02, q=r2/r1=1.75≥t2, and thus the processing device 12 can determine that a non-negligible abnormality occurs in the second period. That is, in the embodiment, in step S50, the processing device 12 detects whether the ratio q of the ratio r of the number of pixels n2 to the number of pixels n1 changes by a predetermined amount or more between adjacent sets of the normal pattern and the inverted pattern of the plurality of sets of the normal pattern and the inverted pattern. Normally, since the ratio r is not to be substantially changed between adjacent sets, the processing device 12 in the embodiment determines whether the number of pixels n2 with low reliability increases based on whether the ratio r changes by a predetermined amount or more. Here, the structured light GS of the set of the normal pattern and the inverted pattern in which the ratio q is equal to or greater than the threshold value t2 is the first structured light GS1. In contrast, when the ratio q is less than the threshold value t2 for all the sets of the normal pattern and the inverted pattern, it is determined that there is no structured light GS whose image is not normally captured, of the M structured lights GS. The processing device 12 may determine whether there is a structured light GS whose image is not normally captured due to a change in the absolute number of the number of pixels n2.

FIG. 7 is a diagram showing abnormality detection when a phase shift pattern is used as the structured light GS. In FIG. 7, when the phase shift pattern is used as the structured light GS, of the M structured lights GS, structured lights GS-c and GS-d, which are two structured lights GS that form inverted images of each other, are representatively shown. FIG. 8 is a diagram showing abnormality detection when a phase shift pattern is used as the structured light GS.

In a phase shift method, as shown in FIG. 7, a plurality of phase shift patterns having stripe patterns whose luminance values change along a sine wave and whose phases are shifted from each other are used. Therefore, when an image of each of the structured light GS-c and the structured light GS-d is captured, a pixel value of the captured image also changes along the sine wave if normal.

Therefore, when the phase shift pattern is used as the structured light GS, in step S40, as shown in FIG. 8, a pixel value (measured value) of a captured image of each structured light GS is fitted with a sine wave, a difference between a fitting result and the pixel value of the captured image is calculated for each pixel, and then a total value of the differences is calculated. In the example shown in FIG. 8, one measured value greatly deviates from the fitting result. In FIG. 8, the measured values are indicated by dots, and fitting results are indicated by a solid line.

In step S50, the processing device 12 determines whether a change in the total value of the differences before and after a projection order is equal to or greater than a threshold value t3. When the change is equal to or greater than the threshold value t3, the processing device 12 determines that there is a structured light GS whose image is not normally captured of the M structured lights GS. In contrast, when the change is less than the threshold value t3, the processing device 12 determines that there is no structured light GS whose image is not normally captured of the M structured lights GS.

A method of determining whether the structured light GS whose image is not normally captured is present is not limited to the example described above, and may be, for example, a method based on a detection result of a human sensor that detects passage of a person between the projector 10 and the projection target SC, or a method based on a detection result of an illuminance sensor that measures illuminance of an installation space of the projection target SC. In an aspect in which presence of a structured light GS whose image is not normally captured is detected using such a sensor, the detection is performed over a projection period during which the projector 10 projects the M structured lights GS. When presence of a structured light GS whose image is not normally captured is detected, the N structured lights GS including the structured light GS with a detected timing are executed again. The projection of the structured light GS may be interrupted during a period in which the passage of a person or a change in illuminance is detected by these sensors, and the projection of the structured light GS may be resumed after the passage of a person or the change in illuminance is no longer detected.

FIG. 9 is a diagram showing an example of messages Rd and Re. In FIG. 9, the image G-M projected on the projection target SC by the projector 10 in step S70 is shown.

The image G-M is the projection image G projected on the projection target SC by the projector 10 in step S70. The image G-M includes a region Rc and the messages Rd and Re.

The region Rc includes a button B3 and a button B4. The button B3 is a display for permitting execution of step S90. The button B4 is a display for not permitting execution of step S90.

The message Rd indicates that there is a possibility that at least one first structured light GS1 is included even when the projection of the N structured lights GS is executed. In the example shown in FIG. 9, a phrase “abnormality may occur if continue” is displayed as the message Rd. A display content of the message Rd is not limited to the example shown in FIG. 9 and is optional.

The message Re includes one or more candidate causes related to the inclusion of at least one first structured light GS1. In the example shown in FIG. 9, a phrase “please check for obstacle before continuing” is displayed as the message Re. A display content and the number of the messages Re are not limited to the example shown in FIG. 9 and are optional.

In the above image G-M, when the button B3 is operated, step S80 is executed, and it is determined in step S80 that step S90 is repeated. When the button B4 is operated, the processing ends without executing step S80.

As described above, the projection method described above includes step S30, step S50, and step S90. The projection method described above includes, when there is at least one first structured light GS1 whose image is not normally captured as a result of capturing images of the M structured lights GS in step S30 (step S50: YES), in step S90, projecting the N structured lights GS including the at least one first structured light GS1, where N is smaller than M, and thus the number of structured lights GS to be projected again can be set to a minimum required number. As a result, even when there is a structured light GS whose image is not normally captured due to disturbance or the like, the number of projected structured light GS can be optimized.

For example, when 46 patterns in the gray code method are used as the structured light GS, assuming that there is an abnormality in three patterns and a time required for capturing one image is one second, in the related art, it takes 46 seconds for first measurement of the structured light method and 46 seconds for redoing the measurement, and thus it takes 92 seconds in total. In contrast, in the projection method according to the present disclosure, redoing of the measurement is as short as 3 seconds at the shortest, and thus a total of 49 seconds is sufficient.

As described above, the projection method according to the embodiment includes step S60 and step S70. In step S70, when it is determined that the N structured lights GS are repeatedly projected equal to or greater than the first number of times and at least one first structured light GS1 is present (step S50: YES and step S60: YES), the optical device 15 is caused to project the message Rd indicating that there is a possibility that at least one first structured light GS1 is generated even when the projection of the N structured lights GS is executed. Accordingly, it is possible to cause a user to determine whether to further execute the projection of the N structured lights GS the first number of times through the message Rd.

As described above, in the step S70, when it is determined that the N structured lights GS are repeatedly projected equal to or greater than the first number of times and at least one first structured light GS1 is present (step S50: YES and step S60: YES), the message Re including one or a plurality of candidate causes for the inclusion of at least one first structured light GS1 is projected from the projector 10. Accordingly, the user can easily grasp one or more candidate causes through the message Re. As a result, it is possible to prompt the user to perform adjustment or the like so that the first structured light GS1 whose image is not normally captured is not generated.

Further, as described above, the projection method in the embodiment includes step S10. In step S10, the projector 10 projects the user interface image G-U to set the first number of times. Accordingly, it is possible to adjust the number of trials of projecting the N structured lights GS according to a desire of the user.

As described above, the projection method according to the embodiment includes step S21 and step S23. In step S21, before sequentially projecting the M structured lights GS onto the projection target SC from the projector 10, the projector 10 projects the first pattern G1 of the uniform first color onto the projection target SC. In step S23, the projection range in which each of the M structured lights GS is projected onto the projection target SC is determined based on the first pattern G1. Whether at least one first structured light GS1 is present in step S50 is determined based on each of the M structured lights GS in the projection range. Accordingly, it is possible to determine the presence or absence of the first structured light GS1 whose image is not normally captured without being affected by an object such as a foreign substance outside the projection range.

### 2. Second Embodiment

A second embodiment of the present disclosure will now be described. In the embodiment described below, elements having effects and functions similar to those in the first embodiment are denoted by the same reference numerals used in the first embodiment, and the detailed description thereof will be omitted as appropriate.

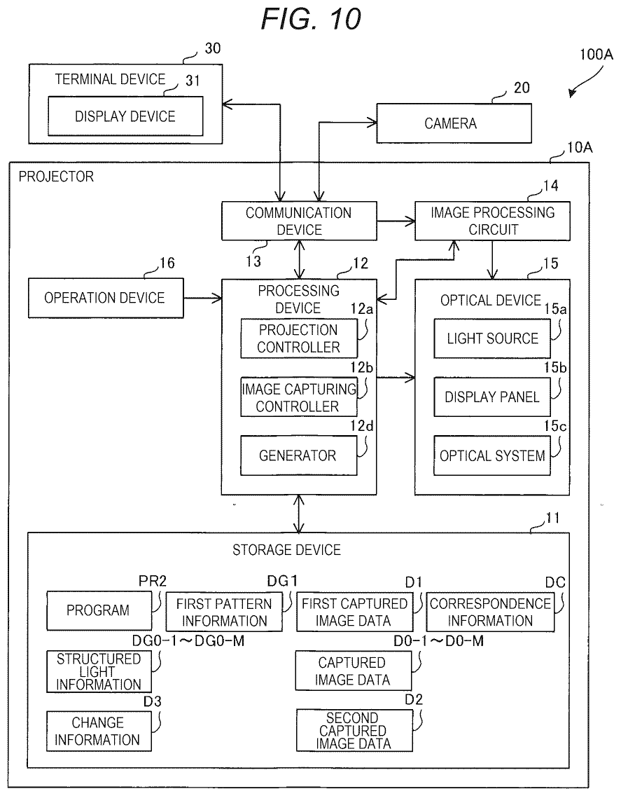

FIG. 10 is a block diagram of a projector 10A used in a projection method according to a second embodiment. The projector 10A according to the embodiment has a configuration similar as the projector 10 in the first embodiment except that a program PR2 is used instead of the program PR1 in the first embodiment. The system 100A used for the projection method according to the second embodiment has a configuration similar as the system 100 in the first embodiment except that the projector 10A is used instead of the projector 10.

In the projector 10A, the processing device 12 executes the program PR2 stored in the storage device 11 and thus functions as the projection controller 12a, the image capturing controller 12b, and a generator 12d. Therefore, the processing device 12 includes the projection controller 12a, the image capturing controller 12b, and the generator 12d.

The generator 12d is similar as the generator 12c in the first embodiment except that the generator 12d has an additional function of generating change information D3 based on the first captured image data D1 and second captured image data D2 and an additional function of performing processing based on the change information D3 when the correspondence information DC is generated.

The second captured image data D2 is information indicating a captured image acquired by capturing an image of the first pattern G1 projected on the projection target SC with the camera 20, and is acquired at a timing different from acquisition of the first captured image data D1.

The change information D3 is information indicating a change in one or both of a position and a posture of the projector 10A with respect to the projection target SC. The change information D3 in the embodiment is specified based on the first captured image data D1 and the second captured image data D2.

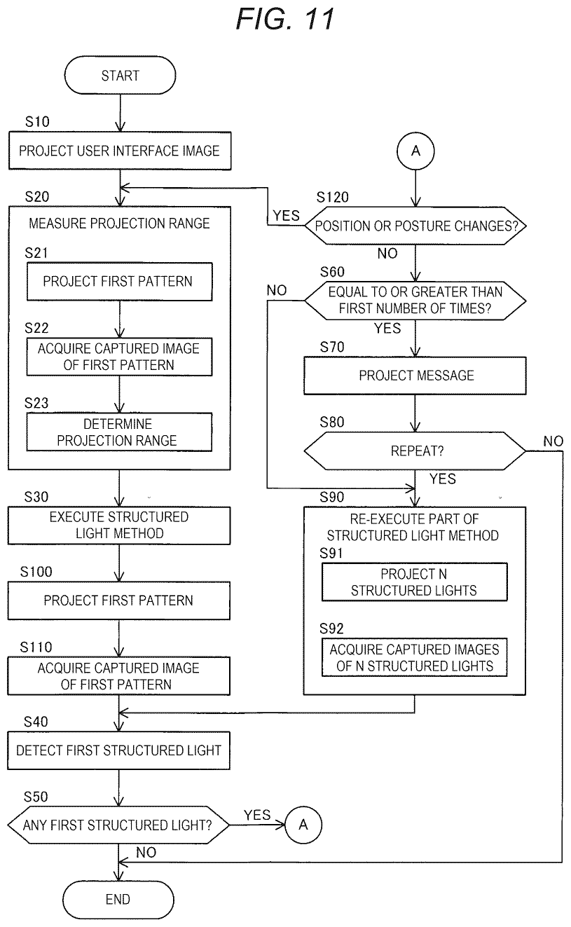

FIG. 11 is a flowchart showing a flow of a projection method according to the second embodiment. The projection method according to the embodiment is similar as the projection method according to the first embodiment except that steps S100, S110, and S120 are added.

In the projection method according to the embodiment, the processing device 12 executes step S100 after step S30. In step S100, similarly to step S21, the projector 10A projects the first pattern G1 onto the projection target SC.

After step S100, the processing device 12 executes step S110. In the step S110, similarly to the step S22, an image of the first pattern G1 projected from the projector 10A onto the projection target SC is captured by the camera 20 in the step S110. By this image capturing, the second captured image data D2 indicating an image capturing result is generated, and the second captured image data D2 is stored in the storage device 11.

After step S110, the processing device 12 executes step S40. When it is determined that at least one first structured light GS1 is present (step S50: YES), the processing device 12 executes step S120.

In step S120, the processing device 12 determines, based on the change information D3, whether one or both of the position and the posture of the projector 10A with respect to the projection target SC are changed.

In the embodiment, the change information D3 is specified based on the first captured image data D1 and the second captured image data D2. Specifically, in step S120, for example, a difference between a pixel value of an image represented by the first captured image data D1 and a pixel value of an image represented by the second captured image data D2 is calculated, and a calculation result is used as the change information D3. In step S120, when the difference is equal to or greater than a predetermined threshold value, it is determined that one or both of the position and the posture of the projector 10A with respect to the projection target SC are changed. In contrast, when the difference is less than the predetermined threshold value, it is determined that one or both of the position and the posture of the projector 10A with respect to the projection target SC are not changed.

When it is determined that one or both of the position and the posture of the projector 10A with respect to the projection target SC are changed (step S120: YES), the processing device 12 returns to step S20. Accordingly, the structured light method using the M structured lights GS in step S30 is executed again.

In contrast, when it is determined that one or both of the position and the posture of the projector 10A with respect to the projection target SC are not changed (step S120: NO), the processing device 12 proceeds to step S60. Accordingly, the structured light method using the M structured lights GS in step S30 is not executed, and the structured light method using the N structured lights GS in step S90 is executed.

According to the projection method described above, even when there is a structured light GS whose image is not normally captured due to disturbance or the like, the number of projected structured light GS can be optimized. In the embodiment, as described above, when it is determined that at least one first structured light GS1 whose image is not normally captured is present as a result of capturing images of the M structured lights GS and one or both of the position and the posture of the projector 10A with respect to the projection target SC are not changed (step S50: YES and step S120: NO), N structured lights GS including the at least one first structured light GS1, where N is smaller than M, are projected, and thus the number of structured lights GS to be projected again can be set to a minimum required number. In contrast, when it is determined that at least one first structured light GS1 whose image is not normally captured is present as a result of capturing images of the M structured lights GS and one or both of the position and the posture are changed (step S50: YES, step S120: YES), since all the M structured lights GS are projected, the number of structured lights GS to be projected again can be set to a required number. As described above, even when there is a structured light GS whose image is not normally captured due to disturbance or the like, the number of projected structured light GS can be optimized.

When one or both of the position and the posture of the projector 10 with respect to the projection target SC change, a captured image of the structured light GS normally captured in step S30 may not be used for the association performed by the processing device 12 after step S50, for example. This is because, when one or both of the position and the posture change, a position where the structured light GS is projected onto the projection target SC is changed, and a condition when an image of the structured light GS is captured by the camera 20 changes before and after one or both of the position and the posture change. Therefore, in order to improve calculation accuracy of the association by the processing device 12, it is preferable to project all the M structured lights GS when one or both of the position and the posture change.

As described above, in the step S22, before the M structured lights GS are sequentially projected from the projector 10A onto the projection target SC, an image of the first pattern G1 of the uniform first color projected from the projector 10A onto the projection target SC is captured by the camera 20, so that the first captured image data D1 is acquired. Further, in the step S110, after the M structured lights GS are sequentially projected from the projector 10A onto the projection target SC and before it is determined whether at least one first structured light GS1 is present, the second captured image data D2 is acquired by capturing an image of the first pattern G1 projected from the projector 10A onto the projection target SC with the camera 20. The change information D3 is specified based on the first captured image data D1 and the second captured image data D2. Accordingly, it is possible to determine presence or absence of a change in one or both of the position and the posture of the projector 10A with respect to the projection target SC without using a sensor other than the camera 20.

### 3. Third Embodiment

A third embodiment of the present disclosure will be described as below. In the embodiment described below, elements having effects and functions similar to those in the first embodiment are denoted by the same reference numerals used in the first embodiment, and the detailed description thereof will be omitted as appropriate.

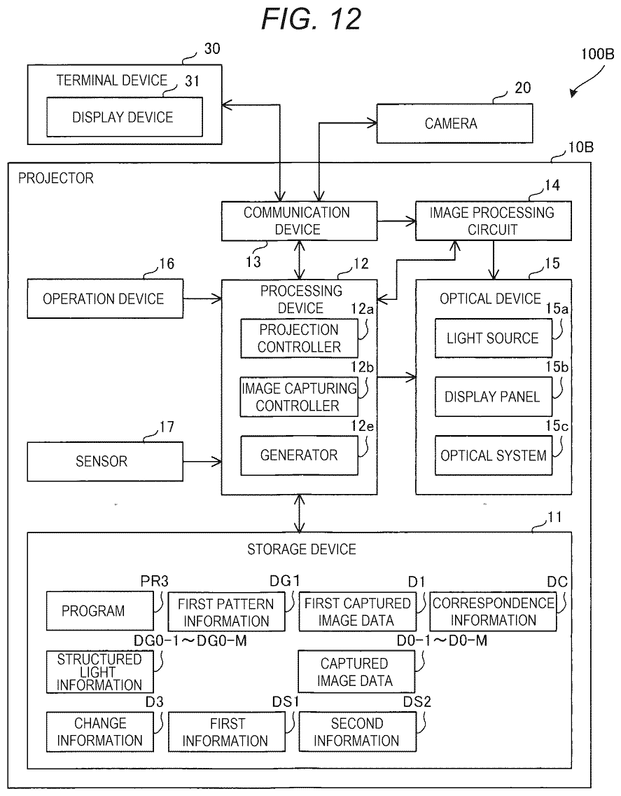

FIG. 12 is a block diagram of a projector 10B used in a projection method according to the third embodiment. The projector 10B according to the embodiment has a configuration similar as the projector 10 in the first embodiment except that a program PR3 is used instead of the program PR1 in the first embodiment, and a sensor 17 is added. A system 100B used for the projection method according to the third embodiment has a configuration similar as the system 100 in the first embodiment except that the projector 10B is used instead of the projector 10.

The sensor 17 is a sensor that detects a change in one or both of a position and a posture of the projector 10B with respect to the projection target SC, and is provided in one or both of the projection target SC and the projector 10B. As the sensor 17, for example, an angular velocity sensor or an acceleration sensor is used. A detection result of the sensor 17 is stored in the storage device 11 as first information DS1 or second information DS2.

In the projector 10B, the processing device 12 executes the program PR3 stored in the storage device 11 and thus functions as the projection controller 12a, the image capturing controller 12b, and a generator 12e. Therefore, the processing device 12 includes the projection controller 12a, the image capturing controller 12b, and the generator 12e.

The generator 12e is similar as the generator 12c in the first embodiment except that the generator 12e has an additional function of generating the change information D3 based on the first information DS1 and the second information DS2 and an additional function of performing processing based on the change information D3 when the correspondence information DC is generated.

The first information DS1 is information indicating one or both of the posture and the position of the projector 10B with respect to the projection target SC before the M structured lights GS are sequentially projected from the projector 10B onto the projection target SC.

The second information DS2 is information indicating one or both of the posture and the position of the projector 10B with respect to the projection target SC after the M structured lights GS are sequentially projected from the projector 10B onto the projection target SC and before it is determined whether at least one first structured light GS1 is present.

The change information D3 in the embodiment is specified based on the first information DS1 and the second information DS2.

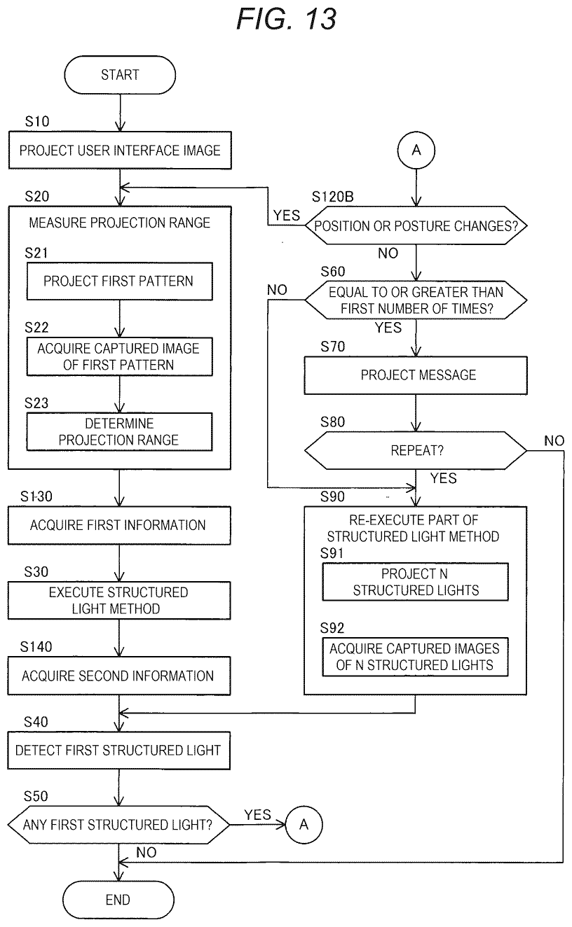

FIG. 13 is a flowchart showing a flow of a projection method according to the third embodiment. The projection method according to the embodiment is similar as the projection method according to the first embodiment except that steps S120B, S130, and S140 are added.

In the projection method according to the embodiment, the processing device 12 executes step S130 after step S20. In step S130, the first information DS1 is acquired based on a detection result of the sensor 17. The acquired first information DS1 is stored in the storage device 11.

After step S130, the processing device 12 executes step S30. After step S30, the processing device 12 executes step S140. In step S140, the second information DS2 is acquired based on a detection result of the sensor 17. The acquired second information DS2 is stored in the storage device 11.

After step S140, the processing device 12 executes step S40. When it is determined that at least one first structured light GS1 is present (step S50: YES), the processing device 12 executes step S120B.

In the step S120B, it is determined, based on the change information D3, whether one or both of the position and the posture of the projector 10B with respect to the projection target SC are changed.

In the embodiment, the change information D3 is specified based on the first information DS1 and the second information DS2. Specifically, in step S120B, for example, a difference between a detection value indicated by the first information DS1 and a detection value indicated by the second information DS2 is calculated, and a calculation result is used as the change information D3. In step S120B, when the difference is equal to or greater than a predetermined threshold value, it is determined that one or both of the position and the posture of the projector 10B with respect to the projection target SC are changed. In contrast, when the difference is less than the predetermined threshold value, it is determined that one or both of the position and the posture of the projector 10B with respect to the projection target SC are not changed.

When it is determined that one or both of the position and the posture of the projector 10B with respect to the projection target SC are changed (step S120B: YES), the processing device 12 returns to step S20. Accordingly, the structured light method using the M structured lights GS in step S30 is executed again.

In contrast, when it is determined that one or both of the position and the posture of the projector 10B with respect to the projection target SC are not changed (step S120B: NO), the processing device 12 proceeds to step S60. Accordingly, the structured light method using the M structured lights GS in step S30 is not executed, and the structured light method using the N structured lights GS in step S90 is executed.

According to the projection method described above, even when there is a structured light GS whose image is not normally captured due to disturbance or the like, the number of projected structured light GS can be optimized. In the embodiment, in step S130, the first information DS1 indicating one or both of the posture and the position before the M structured lights GS are sequentially projected from the projector 10B onto the projection target SC is acquired. In the step S140, the second information DS2 indicating one or both of the posture and the position after the M structured lights GS are sequentially projected from the projector 10B onto the projection target SC and before it is determined whether at least one first structured light GS1 is present is acquired. The change information D3 is specified based on the first information DS1 and the second information DS2. Accordingly, it is possible to determine presence or absence of a change in one or both of the position and the posture of the projector 10B with respect to the projection target SC while reducing the number of times of projection from the projector 10B.

### 4. Modification

The embodiments described above by way of example can be modified in various manners. Specific aspects of modifications applicable to the foregoing embodiments will be described below by way of example. Two or more aspects freely selected from the examples given below can be combined together as appropriate to the extent that no contradiction occurs.

### 4-1. Modification 1

In the embodiments described above, an aspect in which the processing devices 12 of the projectors 10, 10A, and 10B execute the programs PR1, PR2, and PR3 is described as an example, but the present disclosure is not limited to this aspect, and for example, processing devices of computers communicably coupled to the projectors 10, 10A, and 10B and the camera 20 may execute the programs PR1, PR2, and PR3, or a processing device of the camera 20 may execute the programs PR1, PR2, and PR3.

### 4-2. Modification 2

In the embodiments described above, an aspect in which the correspondence information DC is used for adjustment of the projection image G is described as an example, but the present disclosure is not limited to this aspect, and for example, the correspondence information DC may be used for displaying a grid-shaped pattern or the like having uniformity on the projection target SC or may be used for drawing a picture on a three-dimensional shaped model of the projection target SC viewed from the camera 20 after reflecting this model on three-dimensional image editing software or the like, for causing a PC monitor or the like to display how the picture is seen from the projector 10, or for causing the projector 10 to project the picture.

### 4-3. Modification 3

In the second embodiment described above, the change information D3 is specified based on the first captured image data D1 and the second captured image data D2, and in the third embodiment described above, the change information D3 is specified based on the first information DS1 and the second information DS2, but the present disclosure is not limited to this aspect, and for example, the change information D3 may be specified based on a value input by a user. Specifically, when a user inputs a value indicating the change information D3 to the operation device 16, the change information D3 may be specified based on the value or an index. The values are, for example, distances between the projectors 10, 10A, and 10B and the projection target SC and installation angles of the projectors 10, 10A, and 10B. The change information D3 may not be numerical information. For example, the change information D3 may be event information indicating that a change event of at least one of the position and the posture occurs. Contents of the event information is determined based on, a selection result of either “Yes” or “No” when, for example, a confirmation screen including a message such as “projector body moved?” and two options “Yes” and “No” is projected from the optical device 15.

### 5. Appendixes

The present disclosure will be summarized below in the form of appendixes.

(Appendix 1) A first aspect that is a suitable example of a projection method according to the present disclosure includes: acquiring a plurality of pieces of captured image data by capturing an image of each of M structured lights projected from a projector onto a projection target with a camera, M being a natural number equal to or greater than 2; determining, based on the plurality of pieces of captured image data, whether at least one first structured light whose image is not normally captured, of the M structured lights, is present; and projecting N structured lights including the at least one first structured light onto the projection target, N being a natural number smaller than M, when it is determined that the at least one first structured light is present.

In the above aspect, when there is at least one first structured light whose image is not normally captured as a result of capturing images of the M structured lights, the N structured lights including the at least one first structured light, where N is smaller than M, are projected, and thus the number of structured lights to be projected again can be set to a minimum required number. As a result, even when there is a structured light whose image is not normally captured due to disturbance or the like, the number of projected structured light can be optimized.

(Appendix 2) In a second aspect that is a suitable example of the first aspect, the projection method further includes: projecting, from the projector, a message indicating that there is a possibility that the at least one first structured light is generated even when the N structured lights are projected, when the number of repetitions of the projection of the N structured lights is equal to or greater than a first number of times and it is determined that the at least one first structured light is present. In the above aspect, it is possible to cause a user to determine whether to further execute the projection of the N structured lights the first number of times through the message.

(Appendix 3) In a third aspect that is a suitable example of the first or second aspect, the projection method further includes: projecting, from the projector, a message including one or more candidate causes related to inclusion of the at least one first structured light, when the number of repetitions of projection of the N structured lights is equal to or greater than a first number of times and it is determined that the at least one first structured light is present. In the above aspect, the user can easily grasp one or more candidate causes through the message. As a result, it is possible to prompt the user to perform adjustment or the like so that the first structured light whose image is not normally captured is not generated.

(Appendix 4) In a fourth aspect that is a suitable example of the second or third aspect, the projection method further includes: projecting a user interface image for setting the first number of times from the projector. In the above aspect, it is possible to adjust the number of trials of projecting the N structured lights according to a desire of the user.

(Appendix 5) In a fifth aspect that is a suitable example of any one of the first aspect to the fourth aspect, the projection method further includes: projecting a first pattern of a uniform first color from the projector onto the projection target before the M structured lights are sequentially projected from the projector onto the projection target; and determining, based on the first pattern, a projection range in which each of the M structured lights is projected on the projection target, in which the determining whether the at least one first structured light is present is performed based on each of the M structured lights in the projection range. In the above aspect, it is possible to determine the presence or absence of the first structured light whose image is not normally captured without being affected by an object such as a foreign substance outside the projection range.

(Appendix 6) A sixth aspect that is another suitable example of a projection method according to the present disclosure includes: acquiring a plurality of pieces of captured image data by capturing an image of each of M structured lights projected from a projector onto a projection target with a camera, M being a natural number equal to or greater than 2; determining, based on the plurality of pieces of captured image data, whether at least one first structured light whose image is not normally captured, of the M structured lights, is present; determining, based on change information indicating a change in one or both of a position and a posture of the projector with respect to the projection target, whether one or both of the position and the posture are changed; projecting N structured lights including the at least one first structured light onto the projection target, N being a natural number smaller than M, when it is determined that the at least one first structured light is present and one or both of the position and the posture are not changed; and projecting the M structured lights onto the projection target when it is determined that the at least one first structured light is present and one or both of the position and the posture are changed.

In the above aspect, when it is determined that there is at least one first structured light whose image is not normally captured as a result of capturing images of the M structured lights and that one or both of the position and the posture are not changed, N structured lights including the at least one first structured light, where N is smaller than M, are projected, and thus the number of structured lights to be projected again can be set to a minimum required number. In contrast, when it is determined that at least one first structured light whose image is not normally captured is present as a result of capturing the images of the M structured lights and one or both of the position and the posture are changed, since all the M structured lights are projected, the number of structured lights to be projected again can be set to a required number. As described above, even when there is a structured light whose image is not normally captured due to disturbance or the like, the number of projected structured light can be optimized.

(Appendix 7) In a seventh aspect that is a suitable example of the sixth aspect, the projection method further includes: acquiring first captured image data by capturing an image of a first pattern of a uniform first color projected from the projector onto the projection target with the camera, before the M structured lights are sequentially projected from the projector onto the projection target; and acquiring second captured image data by capturing an image of the first pattern projected from the projector onto the projection target with the camera, after the M structured lights are sequentially projected from the projector onto the projection target and before it is determined whether the at least one first structured light is present, in which the change information is specified based on the first captured image data and the second captured image data. In the above aspect, it is possible to determine presence or absence of a change in one or both of the position and the posture of the projector with respect to the projection target without using a sensor other than the camera.

(Appendix 8) In an eighth aspect that is a suitable example of the sixth aspect, the projection method further includes: acquiring first information indicating one or both of the posture and the position before the M structured lights are sequentially projected from the projector onto the projection target; and acquiring second information indicating one or both of the posture and the position after the M structured lights are sequentially projected from the projector onto the projection target and before it is determined whether the at least one first structured light is present, in which the change information is specified based on the first information and the second information. In the above aspect, it is possible to determine presence or absence of a change in one or both of the position and the posture of the projector with respect to the projection target while reducing the number of times of projection from the projector.

(Appendix 9) A ninth aspect that is a suitable example of the projector according to the present disclosure includes: an optical device; and a processing device configured to control an operation of the optical device, in which the processing device is configured to acquire a plurality of pieces of captured image data in which an image of each of M structured lights projected from the optical device onto a projection target is captured by a camera, M being a natural number equal to or greater than 2, determine, based on the plurality of pieces of captured image data, whether at least one first structured light whose image is not normally captured, of the M structured lights, is present, and project N structured lights including the at least one first structured light onto the projection target, N being a natural number smaller than M, when it is determined that the at least one first structured light is present.

In the above aspect, when there is at least one first structured light whose image is not normally captured as a result of capturing images of the M structured lights, the N structured lights including the at least one first structured light, where N is smaller than M, are projected, and thus the number of structured lights to be projected again can be set to a minimum required number. As a result, even when there is a structured light whose image is not normally captured due to disturbance or the like, the number of projected structured light can be optimized.

(Appendix 10) A tenth aspect that is a suitable example of a non-transitory computer-readable storage medium storing a program according to the present disclosure causes a computer to execute operations including: acquiring a plurality of pieces of captured image data in which an image of each of M structured lights projected from a projector onto a projection target is captured by a camera, M being a natural number equal to or greater than 2; determining, based on the plurality of pieces of captured image data, whether at least one first structured light whose image is not normally captured, of the M structured lights, is present; and causing the projector to project N structured lights including the at least one first structured light onto the projection target, N being a natural number smaller than M, when it is determined that the at least one first structured light is present.

In the above aspect, when there is at least one first structured light whose image is not normally captured as a result of capturing images of the M structured lights, the N structured lights including the at least one first structured light, where N is smaller than M, are projected, and thus the number of structured lights to be projected again can be set to a minimum required number. As a result, even when there is a structured light whose image is not normally captured due to disturbance or the like, the number of projected structured light can be optimized.

What is claimed is:

1. A projection method comprising:
acquiring a plurality of pieces of captured image data by capturing an image of each of M structured lights projected from a projector onto a projection target with a camera, M being a natural number equal to or greater than 2;
determining, based on the plurality of pieces of captured image data, whether at least one first structured light whose image is not normally captured, of the M structured lights, is present; and
projecting N structured lights including the at least one first structured light onto the projection target, N being a natural number smaller than M, when it is determined that the at least one first structured light is present.

2. The projection method according to claim 1, further comprising:
projecting, from the projector, a message indicating that there is a possibility that the at least one first structured light is included even when the N structured lights are projected, when the number of repetitions of the projection of the N structured lights is equal to or greater than a first number of times and it is determined that the at least one first structured light is present.

3. The projection method according to claim 1, further comprising:
projecting, from the projector, a message including one or more candidate causes related to inclusion of the at least one first structured light, when the number of repetitions of projection of the N structured lights is equal to or greater than a first number of times and it is determined that the at least one first structured light is present.

4. The projection method according to claim 2, further comprising:
projecting a user interface image for setting the first number of times from the projector.

5. The projection method according to claim 1, further comprising:
projecting a first pattern having a uniform first color from the projector onto the projection target before the M structured lights are projected from the projector onto the projection target; and
determining, based on the first pattern, a projection range in which each of the M structured lights is projected on the projection target, wherein
the determining whether the at least one first structured light is present is performed based on each of the M structured lights in the projection range.

6. A projection method comprising:
acquiring a plurality of pieces of captured image data by capturing an image of each of M structured lights projected from a projector onto a projection target with a camera, M being a natural number equal to or greater than 2;
determining, based on the plurality of pieces of captured image data, whether at least one first structured light whose image is not normally captured, of: the M structured lights, is present;
determining, based on change information indicating a change in one or both of a position and a posture of the projector with respect to the projection target, whether one or both of the position and the posture are changed;
projecting N structured lights including the at least one first structured light onto the projection target, N being a natural number smaller than M, when it is determined that the at least one first structured light is present and one or both of the position and the posture are not changed; and
projecting the M structured lights onto the projection target when it is determined that the at least one first structured light is present and one or both of the position and the posture are changed.

7. The projection method according to claim 6, further comprising:
acquiring first captured image data by capturing an image of a first pattern having a uniform first color projected from the projector onto the projection target with the camera, before the M structured lights are projected from the projector onto the projection target; and
acquiring second captured image data by capturing an image of the first pattern projected from the projector onto the projection target with the camera, after the M structured lights are projected from the projector onto the projection target and before it is determined whether the at least one first structured light is present, wherein
the change information is specified based on the first captured image data and the second captured image data.

8. The projection method according to claim 6, further comprising:
acquiring first information indicating one or both of the posture and the position before the M structured lights are sequentially projected from the projector onto the projection target; and
acquiring second information indicating one or both of the posture and the position after the M structured lights are projected from the projector onto the projection target and before it is determined whether the at least one first structured light is present, wherein
the change information is specified based on the first information and the second information.

9. A projector comprising:
an optical device; and
a processing device configured to control an operation of the optical device, wherein
the processing device is configured to
acquire a plurality of pieces of captured image data in which an image of each of M structured lights projected from the optical device onto a projection target is captured by a camera, M being a natural number equal to or greater than 2,
determine, based on the plurality of pieces of captured image data, whether at least one first structured light whose image is not normally captured, of the M structured lights, is present, and
project N structured lights including the at least one first structured light onto the projection target, N being a natural number smaller than M, when it is determined that the at least one first structured light is present.
